(19) United States
(12) Patent Application Publication
(10) Pub. No.: US 2022/0061363 A1
(43) Pub. Date: Mar. 3, 2022

(54) Degreasing Absorbant Pouch

(71) Applicants: Zack Hayes, Zionsville, IN (US); Scott Hayes, Zionsville, IN (US)

(72) Inventors: Zack Hayes, Zionsville, IN (US); Scott Hayes, Zionsville, IN (US)

(21) Appl. No.: 17/009,776

(22) Filed: Sep. 2, 2020

(51) Int. Cl. A23L 5/20; B01J 20/28; B01J 20/24

(52) U.S. Cl. CPC A23L 5/273; B01J 2220/485; B01J 20/24; B01J 20/2805

(57) ABSTRACT

The invention is a pouch made of all-natural fabric, which contains loose plant-based absorbant capable of absorbing grease through the confines of the bag. The bag is sealed to keep the loose absorbant contained and insertable into a cooking food. Attached to the main body of the bag, a draw string tether connects the small paper tag with the invention's name printed and allows opening and closing the bag for replacing the absorbant therein. The whole product is biodegradable and can suitably be disposed of after use. The disclosed absorbant pouch is made of a material including hemp fiber having a predefined molecular porosity. The organic absorbant in the pouch molecularly bonds with a grease molecule entering through the molecular porosity of the pouch, wherein a combined size of the grease molecule bonded with the organic absorbant is larger than the molecular porosity of the pouch material.

### BACKGROUND

Purposes of cleaning agents include health, beauty, removing offensive odor, and avoiding the spread of dirt and contaminants to oneself and others. Some cleaning agents can kill bacteria (e.g. door handle bacteria, as well as bacteria on worktops and other metallic surfaces) and clean at the same time. Others, called degreasers, contain organic solvents to help dissolve oils and fats. There have been no products available as original equipment or as an aftermarket to address this problem.

Cooking fatty meats cause the grease to separate from the meat. This grease can be difficult to clean by regular methods due to oil's hydrophobic properties. Draining or removing said grease can decrease the calorie count of the meat being cooked. Thus it is sometimes desired to have it removed. There have been no products available as original equipment or as an aftermarket to address this problem either.

There accordingly exists a need for a degreasing absorbant that is not being met by any known or disclosed device or system of present.

### SUMMARY OF THE INVENTION

The invention is a pouch made of all-natural fabric, including hemp fiber which contains loose plant-based absorbant capable of absorbing grease through the confines of the bag. The bag is sealed by sewn edges and an optional draw string edge to keep the loose absorbant contained but replaceable upon use. Attached to the main body of the bag is a draw string tether that connects the small paper tag with the invention's name printed. The whole product is biodegradable and can suitably be disposed of after use. The whole product is hydrophobic and has a flash point higher than typical cooking temperatures of 450 degrees Fahrenheit and is also therefore inserted into cooking food.

A disclosed absorbant pouch device includes an outer pouch having a draw string opening, the pouch comprising a material having a predefined molecular porosity. The device also includes an organic absorbant in the pouch configured to molecularly bond with a grease molecule entering through the molecular porosity of the pouch, wherein a combined size of the grease molecule bonded with the organic absorbant is larger than the molecular porosity of the pouch material. Embodiments of the absorbant pouch device include a draw string configured to seal off an open end of the pouch and a tether from the pouch to a label attached thereto.

### BRIEF DESCRIPTION OF THE DRAWINGS

FIG. 1 is a view of the degreasing pouch with its paper tag attached to a draw string tether in accordance with an embodiment of the present disclosure.

FIG. 2 depicts a fat oil grease (FOG) molecule relative to a molecular porosity of the pouch in accordance with an embodiment of the present disclosure.

FIG. 3 depicts a FOG molecule before and after a molecular bonding with the pouch material in accordance with an embodiment of the present disclosure.

FIG. 4 is a method of absorbing via an organic degreasing pouch with replaceable absorbant in accordance with an embodiment of the present disclosure.

FIG. 5 depicts further methods for absorbing an organic FOG (fat oil grease) compound via an absorbant within a pouch in accordance with an embodiment of the disclosure.

Throughout the description, similar reference numbers may be used to identify similar elements depicted in multiple embodiments. Although specific embodiments of the invention have been described and illustrated, the invention is not to be limited to the specific forms or arrangements of parts so described and illustrated. The scope of the invention is to be defined by the claims appended hereto and their equivalents.

### DETAILED DESCRIPTION

Reference will now be made to exemplary embodiments illustrated in the drawings and specific language will be used herein to describe the same. It will nevertheless be understood that no limitation of the scope of the disclosure is thereby intended. Alterations and further modifications of the inventive features illustrated herein and additional applications of the principles of the inventions as illustrated herein, which would occur to one skilled in the relevant art and having possession of this disclosure, are to be considered within the scope of the invention.

Throughout the present disclosure the term ‘molecular porosity’ is used to refer to a measure of the molecular void spaces in a material which will pass a molecule of a predetermined size. The term ‘absorbant,’ is a noun and refers to an absorbing compound for fats, oils and greases (FOG). The term ‘orthogonally shredded,’ refers to a first shredding parallel with a lateral side and a second shredding at right angles to the first shredding to produce square or rectangular sheets or cubes of material.

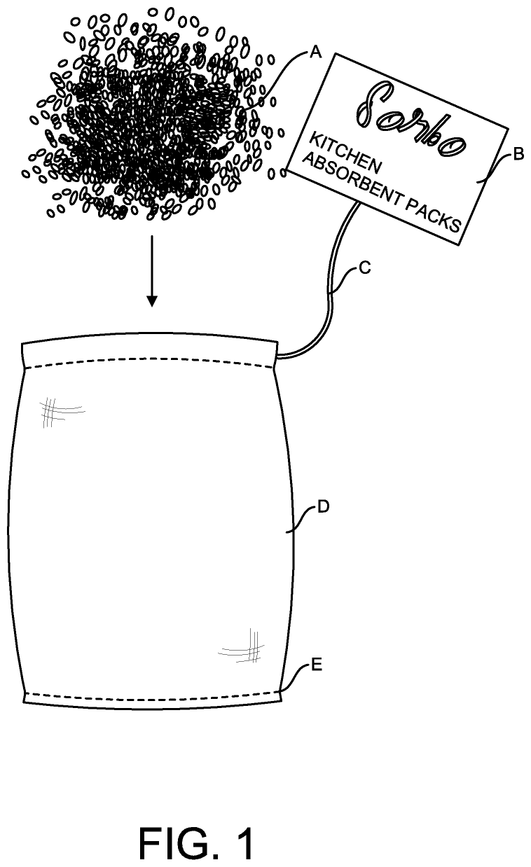

FIG. 1 is a view of the degreasing pouch with its paper tag attached in accordance with an embodiment of the present disclosure. The main pouch body D is sewn together at the edges E to hold said loose plant-based absorbant A within. Attached to the main body is a paper tag B by means of a draw string tether C for cinching the bag close around a replaceable absorbant and for advertising and indicia tags. The plant based absorbant includes orthogonally shredded corn husks. Orthogonally shredded corn husks are small segments of corn husk which expand upon taking on grease molecules and trap the grease in the pouch D. The pouch may also comprise cheesecloth and other loosely woven cotton and one way absorbant materials. One way absorbant materials allow grease molecules to enter the bag but upon bonding with the corn husk and other absorbants inside are too large to leave the bag and are chemically contained therein.

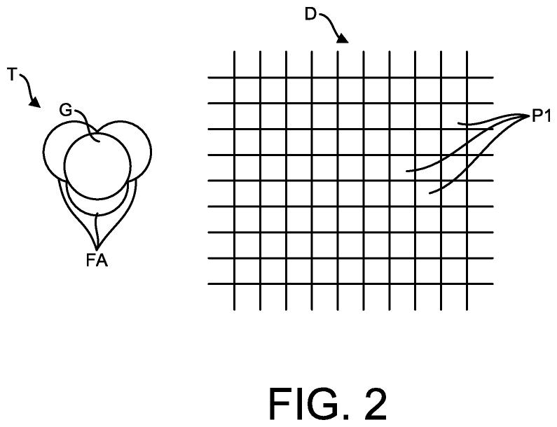

FIG. 2 depicts a fat oil grease (FOG) molecule relative to a molecular porosity of the pouch in accordance with an embodiment of the present disclosure. An exemplary FOG molecule from animal fats and vegetable oils is a triglyceride molecule T comprising a glyceride molecule G and three fatty acids FA to make a TAG molecule. The pouch D has a molecular porosity P1 as indicated smaller than the TAG molecule so the TAG molecule cannot pass through it.

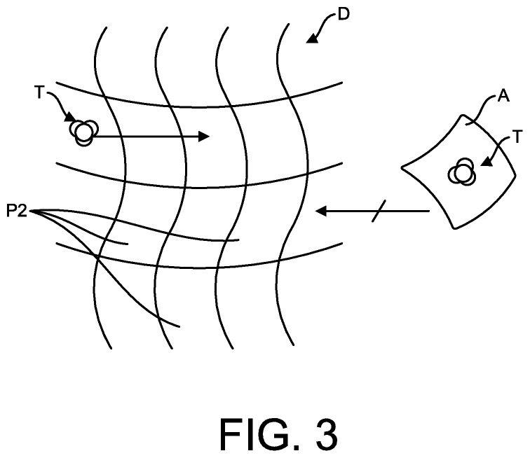

FIG. 3 depicts a FOG molecule before and after a molecular bonding with the pouch material in accordance with an embodiment of the present disclosure. The pouch D in this depiction is large enough to pass the TAG molecule before it bonds with the plant based and organic absorbant A. The combined size of the TAG molecule and the absorbant A traps the TAG inside the pouch since it can no longer pass through the molecular porosity P2 of the pouch D. The left to right arrow depicts a passage of the TAG molecule through the pouch molecular porosity but the right to left crossed arrow depicts a non-passage of the larger combined TAG molecule and absorbant.

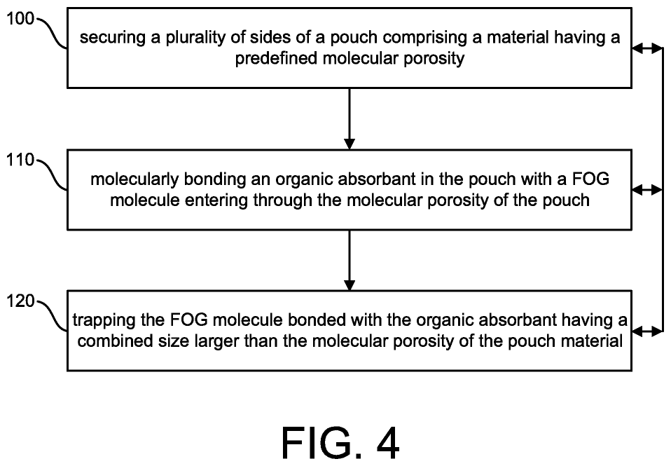

FIG. 4 depicts a method of absorbing via an organic degreasing pouch with replaceable absorbant in accordance with an embodiment of the present disclosure. The method includes securing a plurality of sides of a pouch comprising a material having a predefined molecular porosity. The method also includes molecularly bonding an organic absorbant in the pouch with a FOG molecule entering through the molecular porosity of the pouch. The method additionally includes trapping the FOG molecule bonded with the organic absorbant having a combined size larger than the molecular porosity of the pouch material.

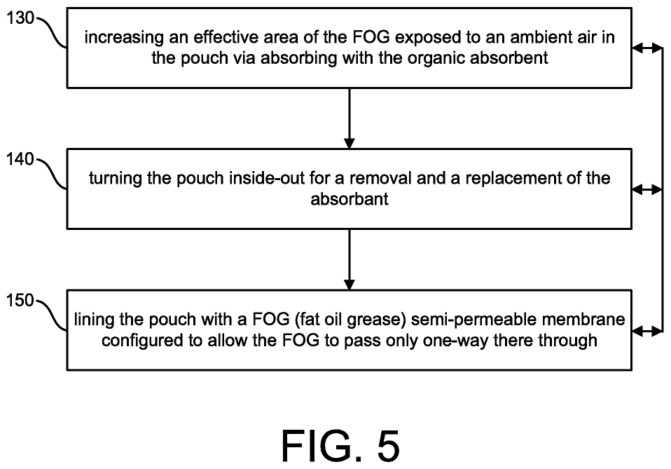

FIG. 5 depicts further methods for absorbing an organic FOG (fat oil grease) compound via an absorbant within a pouch in accordance with an embodiment of the disclosure. Embodiments include increasing an effective area of the FOG exposed to an ambient air in the pouch via absorbing with the organic absorbant. Embodiments also include turning the pouch inside-out for a removal of the absorbant and turning the pouch inside-out for a replacement of the absorbant. Embodiments yet include lining the pouch with a FOG (fat oil grease) semi-permeable membrane configured to allow the FOG to pass only one-way there through.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

While the forgoing examples are illustrative of the principles of the present disclosure in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the disclosure be limited, except as by the specification and claims set forth herein.

What is claimed is:

1. An absorbent device, comprising:
a pouch having secured sides, the pouch comprising a material having a predefined molecular porosity; and
an organic absorbant in the pouch configured to molecularly bond with a grease molecule entering through the molecular porosity of the pouch,
wherein a combined size of the grease molecule bonded with the organic absorbant is larger than the molecular porosity of the pouch material.

2. The device of claim 1, wherein the device comprises a hemp fiber with a flash point higher than a cooking temperature and therefore inserted into a cooking food.

3. The device of claim 1, wherein the organic absorbant is a twice orthogonally shredded corn husk.

4. The device of claim 1, wherein the grease entering the pouch is molecularly trapped within the pouch in the absorbant.

5. The device of claim 1, wherein the pouch is biodegradable and plant derived.

6. The device of claim 1, wherein the organic absorbant is peat moss.

7. The device of claim 1, wherein the outer pouch is compressed and vacuum packed around the absorbant.

8. The device of claim 1, further comprising a draw string closure and a tether to an indicia tag.

9. The device of claim 1, wherein the pouch is turned inside-out for a disposal of the absorbant and a cleaning of the pouch.

10. The device of claim 1, wherein the pouch is turned inside-out for a replacement of the absorbant.

11. An absorbent pouch, comprising:
an outer pouch having a draw string opening, the pouch comprising a material having a predefined molecular porosity; and
an organic absorbant in the pouch configured to molecularly bond with a grease molecule entering through the molecular porosity of the pouch,
wherein a combined size of the grease molecule bonded with the organic absorbant is larger than the molecular porosity of the pouch material.

12. The absorbent pouch of claim 11, wherein the draw string is configured to seal off an open end of the pouch.

13. The absorbent pouch of claim 11, wherein the draw string is also a tether from the pouch to a label attached thereto.

14. The absorbent pouch of claim 11, wherein the pouch comprises a hemp fiber with a flash point higher than a cooking temperature and therefore is inserted into a cooking food.

15. The absorbent pouch of claim 11, further comprising an inner pouch within the outer pouch, the inner pouch comprising the absorbant.

16. A method for a fat, oil, grease (FOG) absorption, the method comprising:
securing a plurality of sides of a pouch comprising a material having a predefined molecular porosity; and
molecularly bonding an organic absorbant in the pouch with a FOG molecule entering through the molecular porosity of the pouch,
trapping the FOG molecule bonded with the organic absorbant having a combined size larger than the molecular porosity of the pouch material.

17. The method of claim 16, further comprising increasing an effective area of the FOG exposed to an ambient air in the pouch via absorbing with the organic absorbant.

18. The method of claim 16, further comprising inserting the pouch into a cooking food to absorb a grease emitted thereby in a cooking of the food.

19. The method of claim 16, further comprising turning the pouch inside-out for a replacement of the absorbant.

20. The method of claim 16, further comprising lining the pouch with a FOG (fat oil grease) semi-permeable membrane configured to allow the FOG to pass only one-way there through.
